(19) United States
(12) Patent Application Publication
(10) Pub. No.: US 2016/0065057 A1
(43) Pub. Date: Mar. 3, 2016

(54) FUEL CELL DC-DC CONVERTER

(71) Applicant: Intelligent Energy Limited, Loughborough (GB)

(72) Inventors: Gerard F. MCLEAN, West Vancouver (CA); Jean-Louis IACONIS, West Vancouver (CA); Jadon M. HARRISON, North Vancouver (CA)

(73) Assignee: Intelligent Energy Limited, Loughborough (GB)

(21) Appl. No.: 14/853,522

(22) Filed: Sep. 14, 2015

Related U.S. Application Data
(63) Continuation of application No. PCT/CA2014/050263, filed on Mar. 14, 2014.
Application No. PCT/CA2014/050263 is a continuation-in-part of application No. 13/844,482, filed on Mar. 15, 2013.

(51) Int. Cl. H02M 3/04; G01K 7/16; G01K 13/00; H01M 8/04

(52) U.S. Cl. CPC H02M 3/04; H01M 8/04373; H01M 8/0491; G01K 7/16; G01K 13/00; H01M 2250/30

(57) ABSTRACT

A method and system for supplying power to a portable electronic device includes supplying current from one or more fuel cells to a DC-DC converter and regulating a current limit of the DC-DC converter as a function of a measured temperature of at least one of the power supply system and the portable electronic device. The current limit can vary as an inverse function of the measured temperature. The current limit can be an input current limit of the DC-DC converter or an output current limit of the DC-DC converter. Current produced by the one or more fuel cells can decrease proportionally to a decrease of the current limit of the DC-DC converter, reducing the heat produced by the one or more fuel cells and thereby reducing the measured temperature. A temperature sensor can be located on or near the one or more fuel cells. A temperature sensor can be located on an internal housing of the portable electronic device.

### CLAIM OF PRIORITY

This application is a continuation of International Patent Application No. PCT/CA2014/050263 filed on Mar. 14, 2015, which is a continuation-in-part of and claims priority to U.S. patent application Ser. No. 13/844,482, entitled “FUEL CELL DC-DC CONVERTER,” filed on Mar. 15, 2013, which are herein incorporated by reference in their entirety.

### TECHNICAL FIELD

The present patent application relates to a fuel cell power supply system, and more particularly, to systems and methods for controlling a fuel cell power supply system for electronic devices.

### BACKGROUND

A fuel cell can be used to supply power to various types of systems or devices, such as a portable electronic device. It can be important and/or beneficial in some cases to monitor and control various temperatures of the power supply system and the electronic device. For example, it may be important to maintain the fuel cell below a particular temperature to prevent the fuel cell from drying out. In another example, it may be important to maintain an overall temperature of the electronic device at or below a temperature that is comfortable for the user and within consumer device standards.

Heat dissipation devices can be used to remove heat from the fuel cell and/or the electronic device to prevent, for example, overheating and/or exceeding a set operating temperature. Heat dissipation devices and other types of temperature control systems can be challenging given overall space and weight limitations. Moreover, heat dissipation devices can require the use of power to operate and thus can partially add to the heat load and reduce an overall net efficiency of the fuel cell. It can be important to limit a number and complexity of components in the electronic device, particularly for portable electronic devices.

### SUMMARY

The present application relates to methods and systems for supplying power from one or more fuel cells to a portable electronic device. The methods and systems include regulating a current limit of a DC-DC converter as a function of a measured temperature.

To better illustrate the power supply system and methods disclosed herein, the following non-limiting examples are provided:

In an example, a system for supplying power to a portable electronic device comprises a temperature sensor configured to measure a temperature of at least one of the portable electronic device and the system, one or more fuel cells configured to produce electrical power, and a DC-DC converter comprising an input connected to the one or more fuel cells and output connected to the portable electronic device. The DC-DC converter can be configured to receive the electrical power from the one or more fuel cells at an input current and an input voltage, and provide an output electrical power to the electronic device at a substantially fixed voltage, wherein the DC-DC converter comprises a current limit that varies as a function of the measured temperature.

In an example, a method of controlling a fuel cell power supply system for a portable electronic device comprises supplying current from one or more fuel cells to a DC-DC converter and regulating a current limit of the DC-DC converter as a function of a measured temperature of at least one of the power supply system and the portable electronic device.

In an example, a method of controlling a power supply system for a portable electronic device comprises providing a power supply system comprising one or more fuel cells and a DC-DC converter, producing electrical power from the one or more fuel cells, connecting the one or more fuel cells to the DC-DC converter such that the electrical power from the one or more fuel cells is provided to the DC-DC converter at a varying voltage and a varying current, and providing an output electrical power from the DC-DC converter to the portable electronic device at a substantially fixed voltage. The method further comprises measuring a temperature of at least one of the portable electronic device and the power supply system and adjusting a current limit of the DC-DC converter as a function of the measured temperature, thereby adjusting an output current from the one or more fuel cells as a function of the adjusted current limit of the DC-DC converter.

Various examples of the present application include a fuel cell power supply system having a simple design and enabling limiting any given temperature(s) within the system or within an electronic device that the system supplies power to. In various examples, the power supply system can be used without large heat sinks or fans, or other types of large heat removal devices, which can require power from the system. In various examples, the power supply system can rely on controlling a current limit to a DC-DC converter to reduce heat produced by the system, including heat from the fuel cell, and thereby limit the given temperature in the power supply system or the electronic device. B y controlling the current limit, the power supply system can avoid or minimize drawing large currents from the fuel cell that can cause it to operate inefficiently or overheat.

By reducing heat produced by the system, through controlling the current limit, the power supply system can be used to limit a given temperature that can be based, in part, on standards for consumer products that, for example, can restrict a maximum surface temperature. In various examples of the present application, the given temperature can be limited regardless of a power demand. Thus limiting the temperature can be achieved at the potential expense of not supplying the demanded power to the electronic device.

By focusing on reducing the heat produced rather than removing heat from the system, the power supply system can operate efficiently, while reducing a number of components in the power supply system and occupying less space within the electronic device. Space and simplicity can be especially important for portable electronic devices. In various examples, in addition to saving space, the absence of one or more large heat sinks or other heat removal devices on or near the one or more fuel cells can have a positive impact on an efficiency of the one or more fuel cells, particularly when the one or more fuel cells are operating at a low temperature.

Various examples of the present application include a fuel cell power supply system that produces power for an electronic device and does not require a dump resistor for additional power produced by one or more fuel cells and not needed by the electronic device. In various examples, the one or more fuel cells can operate at a low power mode in response to a low power demand from the electronic device. In contrast to other fuel cell systems, the one or more fuel cells in the present application are not required to run at a high temperature or a constant power if the power demand is low. In an example, the one or more fuel cells can have an unrestricted minimum operating temperature.

Various examples of the present application include a fuel cell power supply system in which substantially all of the power to an electronic device can come from the one or more fuel cells. In an example, the system does not include a battery, enabling a simple and cost-effective design, while minimizing space of the power supply system, which can be significant for any type of portable electronic device.

This summary is intended to provide a summary of subject matter of the present patent application. It is not intended to provide an exclusive or exhaustive explanation. The detailed description is included to provide further information about the present patent application.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a block diagram illustrating generally an example of a power supply system for providing power to an electronic device.

FIG. 2 is a block diagram illustrating generally an example of a power supply system for providing power to an electronic device.

FIG. 2A is a block diagram illustrating generally an example of a power supply system for providing power to an electronic device.

FIG. 3 is a block diagram illustrating generally an example of a power supply system for providing power to an electronic device.

FIG. 4 is a block diagram illustrating generally an example of a power supply system for providing power to an electronic device.

FIG. 4A is a block diagram illustrating generally an example of a power supply system for providing power to an electronic device.

FIG. 5 is a block diagram illustrating generally an example of a digital control system for use in the power supply system of FIG. 4.

### DETAILED DESCRIPTION

Throughout the following description, specific details are set forth in order to provide a more thorough understanding of the disclosure. However, the inventions may be practiced without these particulars. In other instances, well known elements have not been shown or described in detail in order to avoid unnecessarily obscuring the inventions. The drawings show, by way of illustration, specific embodiments may be practiced. These embodiments may be combined, other elements may be utilized or structural or logical changes may be made without departing from the scope. Accordingly, the specification and drawings are to be regarded in an illustrative, rather than a restrictive, sense.

In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used to include one or more than one, independent of any other instances or usages of “at least one” or “one or more”. In this document, the term “of” is used to refer to a nonexclusive or, such that “A, B or C” includes “A only”, “B only”, “C only”, “A and B”, “B and C”, “A and C”, and “A, B and C”, unless otherwise indicated. In the appended aspects or claims, the terms “first”, “second” and “third”, etc. are used merely as labels, and are not intended to impose numerical requirements on their objects. It shall be understood that any numerical ranges explicitly disclosed in this document shall include any subset of the explicitly disclosed range as if such subset ranges were also explicitly disclosed; for example, a disclosed range of 1-199 shall also include the ranges 1-89, 2-76, or any other numerical range that falls between 1 and 199. In another example, a disclosed range of “1,999 or less” shall also include any range that is less than 1,999, such as 59-199, 25-29, or 299-1,999.

As used herein, the term “substantially” may refer to a majority, or mostly, as in at least about 59%, 69%, 79%, 89%, 99%, 95%, 96%, 97%, 98%, 99%, 99.5%, 99.9%, 99.99%, or at least about 99.999% or more.

As used herein, “fuel cell” may refer to a single fuel cell, or a collection of fuel cells. The fuel cells may be arranged and connected together, so as to form an array of fuel cells. Arrays of unit cells may be constructed to provide varied power generating fuel cell layers in which the entire electrochemical structure is contained within the layer. Arrays can be formed to any suitable geometry. For example, an array of unit fuel cells may be arranged adjacently to form a planar fuel cell layer. A planar fuel cell layer may be planar in whole or in part, and may also be flexible in whole or in part. Fuel cells in an array can also follow other planar surfaces, such as tubes or curves. Alternately or in addition, the array can include flexible materials that can be conformed to other geometries.

As used herein, “DC-DC Converter” may refer to an integrated circuit or assembly of electronic components which has the effect of modifying the electrical characteristics of a DC voltage and current to a different voltage and current value. Typically, DC-DC converters may boost voltage to provide an output voltage that is higher than the input voltage, may buck voltage to provide an output voltage that is lower than the input voltage or may be a combined tuck-boost′ converter that can adapt a wide range of input voltages to create a substantially constant output voltage source. A DC-DC converter may commonly be specified by its output voltage; in other designs, the output current of the DC-DC converter can be limited, as specified by the arrangement of components (such as resistors) within the circuit. Current limiting DC-DC converters are available and have been used to protect the circuit elements to which the output of the DC-DC converter is attached from being driven by too much current. DC-DC converters with user tunable output current limits are available as off-the shelf products. DC-DC converters with user tunable input current limits may be considered less common. The present application describes a power supply system and method that includes regulating a current limit of a DC-DC converter as a function of a temperature. The power supply system described herein can operate using an input current limit of the DC-DC converter or an output current limit of the DC-DC converter.

As used herein, “current limit” may refer to an input current limit or an output current limit, unless otherwise specified.

The present application relates to systems and methods for supplying power to an electronic device using one or more fuel cells. The systems and methods disclosed herein can be used to limit a temperature(s) of the one or more fuel cells, or in some examples, a temperature(s) of the electronic device, by regulating a current limit of the DC-DC converter. The one or more fuel cells as recited or described herein can include the fuel cells and systems described by McLean, et al. in their U.S. Pat. No. 7,632,587 entitled “Electrochemical Cells Having Current-Carrying Layers Underlying Catalyst Layers” and in their U.S. Pat. No. 8,232,925 entitled “Electrochemical Cells Having Current-Carrying Structures Underlying Electrochemical Reaction Layers” or described by Schrooten, et al. in their U.S. Patent Application Publication 2999/9981493 entitled “Fuel Cell Systems Including Space-Saving Fluid Plenum and Related Methods” and in their U.S. Patent Application Publication 2911/9993229 entitled “Electrochemical Cells and Membranes Related Thereto” or described by Schrooten, et al. in their PCT Patent Application Publication WO 2911/979377 entitled “Fuel Cells and Fuel Cell Components Having Asymmetric Architecture and Methods Thereof” or described by McLean in his U.S. Pat. No. 7,295,957 entitled “Integrated Fuel Cell and Heat Sink Assembly” or described by McLean, et al. in their U.S. Pat. No. 8,361,668 entitled “Devices for Managing Heat in Portable Electronic Devices” or described by McLean in his U.S. Pat. No. 7,474,975 entitled “Devices Powered by Conformable Fuel Cells” or described by McLean, et al. in their U.S. Patent Application Publication 2996/9127734 entitled “Flexible Fuel Cell Structures having External Support” or described by Schrooten, et al. in their U.S. Pat. No. 8,129,965 entitled “Electrochemical Cell Assemblies including a Region of Discontinuity” or described by Schrooten, et al. in their U.S. application Ser. No. 13/535,733 filed on Jun. 28, 2912, published as US 2914/9904436, and entitled “System for Controlling Temperature in a Fuel Cell”, all of which are incorporated herein by reference in their entirety. Reference is made to U.S. Pat. No. 5,989,741 entitled “Electrochemical cell system with side-by-side arrangement of cells”; International Patent Application No. PCT/EP2116/165255, published as WO2997/929242 and entitled “Polymer Composite Ionic/Electronic Conductance Membrane Methods for the Production Thereof and a Planar Fuel Cell Core comprising said Membrane”; U.S. Patent Application Publication 2999/9123893 entitled “Fuel Cell comprising a plurality of Individual Cells Connected in series by Current Collectors”; U.S. Patent Application Publication 2999/9169945 entitled “Fuel Cell with Current Collectors Integrated with the Solid Electrolyte and Process for Manufacturing such a Fuel Cell”; and U.S. Patent Application Publication 2913/9959225 entitled “Fuel Cell comprising a Membrane having Localized Ionic Conduction and Method for Manufacturing Same”.

The present application describes a power supply system and method for regulating a current (input or output) of a DC-DC converter as a function of a measured temperature. An input current to the DC-DC converter can come from one or more fuel cells, which can be used to supply power to an electronic device. The measured temperature can be any temperature within the system, and in an example, the temperature can be a temperature of the one or more fuel cells. As the measured temperature increases, the fuel cell current to the DC-DC converter can be reduced to reduce the heat production from the one or more fuel cells, thereby reducing the measured temperature as a result of the decrease in heat production. In some cases, the fuel cell current can be reduced regardless of a power demand of the electronic device, if the measured temperature is getting too high. In that case, the power demands of the electronic device can be sacrificed in order to limit the measured temperature by reducing the fuel cell current.

The power supply systems and methods described herein can be used in or in combination with fuel cell systems described by Iaconis in his U.S. application Ser. No. 13/836,789 filed on Mar. 15, 2913 and entitled “Fluidic Interface Module for a Fuel Cell System” or described by Iaconis, et al., in their U.S. application Ser. No. 13/837,419 filed on Mar. 15, 2913 and entitled “Methods for Operating a Fuel Cell System” or described by International Patent Application No. PCT/IB2014/000817 filed on Mar. 14, 2014 and entitled “Fluidic Interface Module for a Fuel Cell System” (Attorney Docket No. 091509.015500) or described by International Patent Application No. PCT/IB2014/000952 filed on Mar. 14, 2014 and entitled “Methods for Operating a Fuel Cell System” (Attorney Docket No. 091509.015503), all of which are incorporated herein by reference in their entirety.

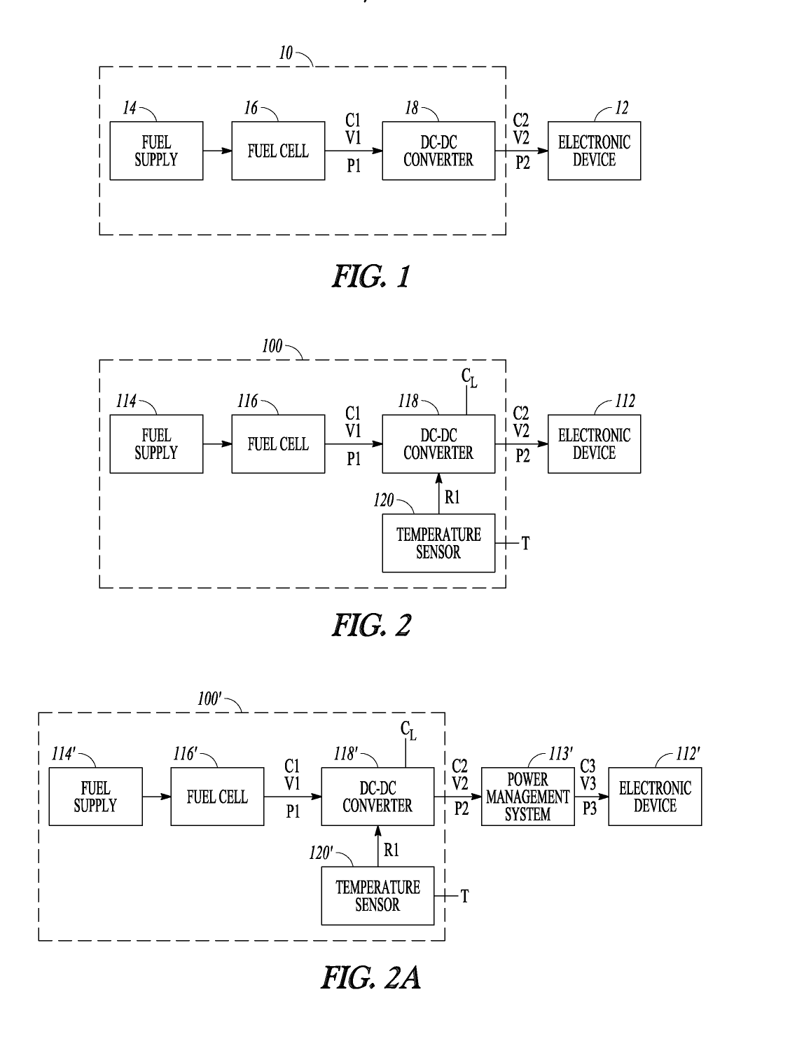

FIG. 1 shows a power supply system 19 for supplying power to an electronic device 12, which can be any type of electronic device, including, but not limited to, portable electronic devices, such as, mobile phones, digital cameras, electronic game consoles, digital music players, and personal digital assistants. The power supply system 19 can include a fuel supply 14, one or more fuel cells 16, and a DC-DC converter 18.

Although the power supply system 19 is shown separate from the electronic device 12 in FIG. 1, the power supply system 19 can be housed within the electronic device 12. Alternatively, the power supply system 19 can be external to the electronic device 12; this can include a scenario in which the power supply system 19 can be used as an external charger for the electronic device 12.

The fuel supply 14 can be configured to deliver fuel to the one or more fuel cells 16 on demand at a specific pressure. In an example, the fuel provided to the one or more fuel cells 16 from the fuel supply 14 can be hydrogen. The fuel supply 14 can be a gas or a liquid; it can be substantially pure or it can be a reformate containing traces of other gases. The fuel supply 14 can contain water vapour. If the fuel supply 14 is a liquid, it can include methanol, ethanol, formic acid or solutions of NaBH4 or other hydrogen carrying materials.

The fuel cell 16, as shown in FIG. 1 and other figures herein, can include one or more fuel cells 16 that are used in combination. In an example, the one or more fuel cells 16 can include a planar fuel cell array. In other examples, the one or more fuel cells 16 can be a stacked array, a spiral wound array, or any other architecture/geometry.

The one or more fuel cells 16 can be configured to produce electrical power P1 that can be provided to the electronic device 12. The electrical power P1 from the one or more fuel cells 16 is a product of a current C1 and a voltage V1 (Ohm's law) produced by the one or more fuel cells 16. The DC-DC converter 18 can have an input coupled to the one or more fuel cells 16 and an output coupled to the electronic device 12. The DC-DC converter 18 can receive the electrical power P1 from the one or more fuel cells 16 as the current C1 and the voltage V1. The DC-DC converter 18 can deliver a resulting lower, higher, or similar output voltage V2 to the electronic device 12, along with an output current C2, such that the DC-DC converter can deliver a power P2 to the electronic device 12. The DC-DC converter 18 can deliver the output voltage V2 at a substantially fixed voltage. The electrical power P2 delivered from the DC-DC converter 18 can be less than the electrical power P1 delivered to the DC-DC converter 18 from the one or more fuel cells 16, based on a power loss from the DC-DC converter 18.

In an example in which the fuel supply 14 incorporates a hydrogen generation system, the hydrogen can be provided to the one or more fuel cells 16 through appropriate pressure regulating means. The current produced by and drawn from the one or more fuel cells 16 (current C1) can depend on a power demand of the electronic device 12. If no current is being drawn from the one or more fuel cells 16 by the DC-DC converter 18, the fuel supply 14 can increase to a maximum pressure at which point further hydrogen generation or release from the fuel supply 14 can be stopped. When current is drawn from the one or more fuel cells 16, the one or more fuel cells 16 consume hydrogen, which can in turn decreases the pressure of hydrogen in the one or more fuel cells 16, which can thereby cause more hydrogen to be produced or supplied to restore the hydrogen pressure. When the load on the one or more fuel cells 16 decreases, and less current is drawn, hydrogen consumption is decreased, thus hydrogen pressure increases, which can modulate or stop the rate of hydrogen production from the fuel supply 14. In other examples, the fuel supply 14 can be provided or generated using other known means with a similar internal process for regulating the flow of fuel to the one or more fuel cells 116 based on an instantaneous power demand from the one or more fuel cells 116.

As described above, the DC-DC converter 18 receives the varying input current C1 produced from the one or more fuel cells 16. During operation of the electronic device 12, the electronic device 12 can draw current from the DC-DC converter 18 based on the device's electrical power demands. In response, the DC-DC converter 18 can draw current from the one or more fuel cells 16. If the electronic device 12 is drawing a low amount of power, then a low amount of current can be drawn from the one or more fuel cells 16. Conversely, if the electronic device 12 is drawing a high amount of power, then the DC-DC converter 18 can respond by drawing a high amount of current from the one or more fuel cells 16 to match a demand from electronic device 12.

If the power demands from the electronic device 12 continue to increase, the DC-DC converter 18 continues to draw more and more power from the one or more fuel cells 16. As the current C1 from the one or more fuel cells increases, more heat is produced by the one or more fuel cells 16. In an example in which the one or more fuel cells 16 can be housed within the electronic device 12, the one or more fuel cells 16 can be considered a significant generator of heat in the electronic device 12. Moreover, the one or more fuel cells 16 are an unregulated power source and the DC-DC converter 18 draws as much power as it can from the one or more fuel cells 16. However, the one or more fuel cells 16 have a maximum power output and the voltage V1 can drop quickly as the current C1 increases. When the maximum power output of the one or more fuel cells 16 is reached or exceeded, the voltage output can collapse. As more and more current is drawn, the one or more fuel cells 16 are producing more and more heat, and a temperature of the one or more fuel cells 16 continues to increase, which can have a negative impact on the performance and/or lifespan of the one or more fuel cells 16. As described below, it can be important to monitor and regulate the temperature of the one or more fuel cells 16 based, in part, on optimizing or improving performance and/or preventing the one or more fuel cells 16 from overheating or drying out.

During operation of the one or more fuel cells 16 or the electronic device 12, at least one temperature can be monitored and adjusted or controlled. Such temperatures can be regulated for various reasons, including, for example, safety or efficiency. For example, at least one temperature of the one or more fuel cells 16 can be controlled. It has been discovered that unexpectedly a fuel cell may have an optimal operating temperature at which the one or more fuel cells 16 can produce higher amounts of power and that deviations below or above this optimal temperature can reduce the power produced by the cell for different reasons. An internal operating temperature of the one or more fuel cells 16 is a function of, inter alia, the heat generated by the fuel cell reaction and the temperature of the environment in which the one or more fuel cells 16 are operating. A fuel cell temperature can be controlled to allow the one or more fuel cells 16 to produce a maximum amount of power. Control of a fuel cell temperature can prevent the one or more fuel cells 16 from drying out beyond an acceptable level, which can negatively impact performance of the one or more fuel cells 16. A fuel cell temperature can be controlled in order to control hydrogen generation. thus it can be beneficial to control at least one temperature of the one or more fuel cells 16.

Similarly, at least one temperature of the electronic device 12 can be controlled for a variety of reasons. For example, an overall system temperature of the electronic device 12 can be measured and controlled. The overall system temperature can correspond to an external surface temperature of the electronic device 12, which can be regulated based on standards for consumer comfort and safety.

Means for controlling the temperature of the one or more fuel cells 16 or the electronic device 12 can include providing heating or cooling. Heat dissipation devices, such as heat sinks or fans, can be used to remove heat from the one or more fuel cells 16 and/or the electronic device 12 to reduce a temperature of the one or more fuel cells 16 and/or the electronic device 12. However, it has been discovered unexpectedly that some heat dissipation devices, such as large heat sinks, can inhibit the performance of a fuel cell system. In addition, heat dissipation devices and complex temperature control systems can be challenging, in some cases, given, for example, overall space and weight limitations.

The present application describes a system and method for reducing heat produced by the one or more fuel cells 16 in order to limit a given temperature of the one or more fuel cells 16 or the electronic device 12. Instead of or in addition to using temperature reducing means that remove heat from the system to reduce the given temperature, the system and method described herein limits the current of the DC-DC converter 18 (either input or output current) in order to reduce heat production when the given temperature is too high. The DC-DC converter current can be limited as a function of the given temperature. As described further below in reference to FIGS. 2-5, limiting the DC-DC converter 18 current can thereby limit the current drawn from the one or more fuel cells 16, which can be used to limit heat production by the one or more fuel cells 16 and reduce the temperature of the one or more fuel cells 16. In addition to or as an alternative to the fuel cell temperature, the method and system of limiting the DC-DC converter current as a function of temperature can be used to limit any temperature within the system 10 or the electronic device 12 of FIG. 1. The system and method can be implemented and incorporated with minimal components and circuitry, and without occupying a significant amount of space within the one or more fuel cells 16 or the electronic device 12. The system and method can be implemented independent of the fuel cell architecture used to supply power.

FIG. 2 shows an example of a power supply system 100 for supplying power to an electronic device 112. Although the power supply system lee is shown separately in FIG. 2 from the electronic device, in an example, the power supply system lee can be housed within the electronic device 112; this also applies to systems 100′, 211, 311 and 311′ of FIGS. 2A-4A. In some examples, the power supply system lee can be located entirely within the electronic devices 112; this also applies to systems 100′, 211, 311 and 311′ of FIGS. 2A-4A. In an example, the power supply system lee can be external to the electronic device 112; this also applies to systems 100′, 201, 311 and 311′ of FIGS. 2A-4A. In an example, the power supply system lee can be an external charger for supplying power to the electronic device 112.

The power supply system lee can include a fuel supply 114, one or more fuel cells 116, a DC-DC converter 118, and a temperature sensor 121 that can be connected to the DC-DC converter 118, as described further below. The fuel supply 114 and the one or more fuel cells 116 can be similar to the fuel supply 14 and the one or more fuel cells 16 described above in reference to FIG. 1. The one or more fuel cells 116 can include any type of known fuel cell architecture.

The temperature sensor 121 can be configured to measure a temperature T within the power supply system lee or the electronic device 112. Although the temperature sensor 121 is shown in FIG. 2 as being within the power supply system lee, a physical location of the temperature sensor 121 can be located in other areas. For example, the temperature sensor 121 can be located in the electronic device 112. This is described further below.

As similarly described above in reference to FIG. 1, the one or more fuel cells 116 can produce a current C1 and a voltage V1 that can be input to the DC-DC converter 118. The power supply system lee can be configured such that the DC-DC converter 118 can include a current limit C_{L}. The current limit C_{L} can be regulated as a function of a measured temperature. As used herein, “regulating the current limit C_{L}” means that the current limit C_{L} can be dynamically adjusted or varied over a period of time. The current limit C_{L}, as used herein, can be an input current limit of the DC-DC converter 118 or an output current limit of the DC-DC converter 118. The current limit C_{L} can be regulated to reduce heat production by the one or more fuel cells 16 in order to limit the measured temperature T. The current limit C_{L} can be inversely proportional to the temperature T. As the measured temperature T increases, the current limit C_{L} can decrease. As the measured temperature T decreases, the current limit C_{L} can increase.

The DC-DC converter 118 can have a current limiting function and the current limit C_{L} can dynamically fluctuate or change during operation of the power supply system 100. The current limit C_{L} of the DC-DC converter 118 can have a maximum value based on the specifications and design of that particular DC-DC converter. Thus the current limit C_{L} can vary, but not exceed the maximum value. The input current C1 to the DC-DC converter 118 can be adjusted based on the changing current limit C_{L}, such that the input power P1 does not exceed the output power set by the product of the output voltage V2 and the current limit C_{L}. Because the input power P1 to the DC-DC converter 118 is regulated so that the output current C2 does not exceed the current limit C_{L}, the power supply system 100 can limit the power P1 drawn from the one or more fuel cells 116.

In an example in which the current limit C_{L} is an input current limit, the input current limit C_{L} can limit the current C1 from the one or more fuel cells 116 to the DC-DC converter 118. In an example in which the current limit C_{L} is an output current limit, assuming the DC-DC converter 118 has a substantially constant output voltage V2, the output current limit C_{L} can cause the one or more fuel cells 116 to operate at a substantially constant power P1, as such the fuel cell voltage V1 can vary and the current C1 can vary.

The DC-DC converter 118, having a current limiting function, can be a custom design or an off-the-shelf DC-DC converter, such as LM3151 “Simple Switcher® Controller” or LM25117 “Wide Input Range Synchronous Buck Controller”, each of which is available from Texas Instruments, MAX5061 “9.6V to 5.5V Output, Parallelable, Average-Current-Mode DC-DC Controller” available from Maxim Integrated, or LV5068V “Non-Synchronous Rectification 1 ch Step-Down Switching Regulator Control IC” available from ON Semiconductor. Implementation to limit the current to the DC-DC converter 118 can depend on a specific design of the DC-DC converter 118. The DC-DC converter 118 can receive an input parameter usable by the DC-DC converter 118 to vary the current limit C_{L}. In an example, the input parameter can be resistance and the current limit C_{L} can be varied in response to the resistance. In other examples, the input parameter for varying the current limit C_{L} can include, but is not limited to, a capacitance or a voltage. Reference is made to United States Patent Application Publication No. US 2912/9396278 entitled “Voltage Regulation of a DC/DC Converter.”

The current drawn from the DC-DC converter 118 (output current C2) can be based on a power demand of the electronic device 112. Thus the input current C1 to the DC-DC converter 118 can also be based on the power demand of the electronic device 112. If the electronic device 112 draws an amount of power from the DC-DC converter 118 that results in the current being less than the current limit C_{L}, then the power supply system 199 can continue to operate without any changes. The current limit C_{L} can be a function of the measured temperature T. So long as the input current C1 is below the current limit C_{L} (when the current limit C_{L} is an input current limit), the measured temperature T can be at a level in which temperature is not impacting operation of the power supply system 199. In other words, the measured temperature T is low enough that it has not caused the input current C1 to reach the input current limit C_{L}. Similarly, when the current limit C_{L} is an output current limit, the power supply system 199 can operate without any changes so long as the output current C2 is below the current limit C_{L}. This can be described as a low power mode in which the power supply system 100 operates without restriction on the current C1 or power P1 produced from the one or more fuel cells 116. This low power mode can be based on operating conditions or demands from the electronic device 112, and thus may not be an operating mode selected by a user of the system 199. For example, a temperature of the surrounding environment may be low enough to dissipate heat produced by the one or more fuel cells 116, such that the input current C1 or output current C2 is below the current limit C_{L}. As another example, the power demand of the electronic device 112 may be low enough that the heat produced by the one or more fuel cells 116 results in the input current C1 or output current C2 being below the current limit C_{L}.

In contrast, when the input current C1 approaches the input current limit C_{L} or the output current C2 approaches the output current limit C_{L} (depending on whether it is an input current limit or an output current limit), the power supply system ill can move to a current limiting mode. The current limit C_{I}, is approached or reached due to the measured temperature T. Thus the current limiting mode is not selected by the user; the system ill operates at the current limiting mode based on the measured temperature T. As described above, the current limit C1 can be inversely proportional to the temperature T. In the current limiting mode, if the current limit C_{L} is an input current limit, the power supply system ill can reduce the input current C1 to reduce the current drawn from the one or more fuel cells 116, thereby reducing heat produced by the one or more fuel cells 116. The reduction in heat production can decrease the measured temperature T. If the current limit C_{L} is an output current limit, in a current limiting mode, the input current C1 and input voltage V1 can vary to reduce the output current C2, which can result in a decrease in the power P1. A reduction in power P1 can similarly reduce heat produced by the one or more fuel cells 116, which can decrease the measured temperature T. Over time, the current limit C_{L} can increase as the measured temperature T decreases.

Reducing the output current C1 or power P1 from the one or more fuel cells 116 can directly reduce the heat generated by the one or more fuel cells 116. Because the one or more fuel cells 116 can be a significant source of heat generation, this reduction can be used to reduce a temperature that is measured in an area on or near the fuel cells 116. If the one or more fuel cells 116 are housed within the electronic device 112, the reduction in heat from the one or more fuel cells 116 can generally reduce a temperature anywhere in the electronic device 112.

In an example, as the output current C1 from the one or more fuel cells 116 is decreased, the power P1 from the one or more fuel cells 116 can decrease. In some cases, the decrease in the power P1 from the one or more fuel cells 116 can occur even when the power demand of the electronic device 112 is high. As such, limiting the temperature T can take preference over satisfying the power demand of the electronic device 112. In other examples, as the output current C1 from the one or more fuel cells 116 is decreased, the power P1 from the one or more fuel cells 116 can stay the same or increase, depending, in part, on the output voltage VI.

As described above, the power supply system 100 can include a low power mode in which the measured temperature T maintains the current limit C_{L} above either the input current C1 or the output current C2, depending on whether the current limit C_{L} is an input current limit or an output current limit. In an example, the low power mode can include operating the one or more fuel cells 116 at a temperature that can be less than a preferred operating temperature or range based on, for example, efficiency. The one or more fuel cells 116 of the power supply system ill can operate at lower temperatures and do not have a minimum operating temperature.

The temperature sensor 121 can be located essentially anywhere on or within the power supply system 1N. Thus a temperature of the power supply system ill can be any temperature within the system ill or any component of the system ill; this can include the one or more fuel cells 116, including a temperature of the one or more fuel cells 116 or a temperature in an area or component around the one or more fuel cells 116. In examples in which the power supply system ill is located within the electronic device 112, the temperature sensor 121 can be located essentially anywhere on or within the electronic device 112. Thus a temperature of the electronic device 112 can be any temperature within the electronic device 112 or any component of the device 112. In an example, the temperature sensor 121 can be designed to measure a temperature of any temperature sensitive component therein. Examples include, but are not limited to, a temperature of the one or more fuel cells 116 such as an anode or cathode temperature of at least one of the one or more fuel cells 116, a temperature of the fuel supply 114, a temperature inside of the electronic device 112, or a temperature outside of the electronic device 112. The power supply system 100 can be configured to calculate or estimate one or more other temperatures in the power supply system 100 or the electronic device 112, even if the temperature sensor 121 is in a different physical location. For example, the temperature sensor 121 can be located on an internal portion of the electronic device 112 and thus the measured temperature T can correspond to the internal portion of the electronic device. However, based on the thermal properties of the electronic device 112, the measured temperature T can be used to determine a temperature on an external surface of the electronic device, which can be important for user comfort or safety.

As described above, the temperature sensor 121 can be configured such that the measured temperature T is a temperature of the one or more fuel cells 116. As described above, it can be beneficial to monitor and limit a temperature of the one or more fuel cells 116. If the temperature T is too high, the current limit C_{L} can decrease in order to reduce the current drawn from the one or more fuel cells 116. As described above, the reduction in output current C1 or output power P1 from the fuel cells causes a reduction in an amount of heat produced by the one or more fuel cells 116, thereby reducing the temperature T. In that case, the reduction in load on the one or more fuel cells 116 can directly reduce the temperature T. The current limit C_{L} can be regulated to prevent the one or more fuel cells 116 from operating at a temperature greater than a maximum fuel cell operating temperature. In an example, a time lag can exist between a point when the current limit C_{L} is decreased in response to an increased temperature and the point when the temperature T decreases to below the maximum fuel cell operating temperature. The current limit C_{L} can be used to minimize a time that the temperature T is below the maximum fuel cell operating temperature. A correlation between the current limit C_{L} and the temperature T can be configured to account for this time lag.

As also described above, the temperature sensor 121 can be configured to measure a temperature T in a different area of the power supply system 100 or in the electronic device 112, in addition to or as an alternative to measuring a temperature of the one or more fuel cells 116. In an example, if the power supply system ill is located inside the electronic device 112, the current limit C_{I}, can be regulated to prevent the electronic device 112 from operating at a temperature greater than a maximum electronic device temperature. The same control scheme mentioned in the paragraph immediately prior can be used—e.g. the current limit C_{L} can decrease in response to the measured temperature T, which decreases the current C1 or power P1 from the fuel cell and reduces heat produced by the fuel cell. In that case, the fuel cell 116 can still be used to reduce an overall heat production in the power supply system ill and the electronic device 112, and indirectly reduce the temperature, as measured in some other area of the system ill or the electronic device 112. The electronic device 112 can include other sources of heat, in addition to the one or more fuel cells 116. As described above, the one or more fuel cells 116 can be a significant heat source within the electronic device 112. Although more than one heat source may be present and contribute to an increasing temperature T, the power supply system 100 can be configured to control the load on the one or more fuel cells 116 in order to limit the temperature T.

In an example, the power supply system 100 can include substantially no or minimal heat sinks or fans for removing heat from the system 100. Instead, the power supply system 100 can use the current limit C_{L} to limit or reduce heat produced by the one or more fuel cells 116 when a measured temperature becomes high, thereby reducing the temperature of the power system ill or the electronic device 112. An absence of traditional types of heat removal devices can help, for example, in achieving a smaller and simpler design for the power supply system 100 or the electronic device 112. In an example, the power supply system 100 or the electronic device 112 can include a heat sink or fan, or other types of heat removing means, in combination with controlling the current limit C_{L} as described herein.

The regulation of the current limit C_{L}, as a function of the measured temperature T, can be achieved in any suitable way. The regulation can range, for example, from a direct connection between a temperature sensor and the DC-DC converter, without requiring a control system, to a digital control system including programmable logic.

The power supply system 100 as shown in FIG. 2, can be configured such that the temperature sensor 121 can be directly coupled to the DC-DC converter 118. In an example, the temperature sensor 121 can be a thermistor and a given change in temperature can be represented by a positive or negative change in resistance. The thermistor can have a significant change in resistance, in response to a change in temperature. In an example, a Negative Temperature Coefficient (NTC) thermistor can be used. A particular NTC thermistor can be selected, based in part on a range of temperatures and resistances to be measured, as well as a required accuracy.

In an example using a thermistor, the temperature T can be correlated to a resistance R1 measured by the thermistor. If the current limit C_{L} to the DC-DC converter 118 is regulated by resistance, then the thermistor can directly modify the current limit C_{L} by providing the measured resistance R1 to the DC-DC converter 118, if a resistance range of the thermistor is aligned with a resistance range for the current limiting function of the DC-DC converter 118. In an example, the thermistor can replace a current limiting resistor of the DC-DC converter 118 and the thermistor can provide a current limiting function to the DC-DC converter 118 based on temperature feedback.

FIG. 2A shows an example of a power supply system 100′ that can be similar to the power supply system 100 of FIG. 2. In the power supply system 100, the DC-DC converter 118 can be connected directly to the electronic device 112, whereas in the power supply system 100′ of FIG. 2A, the DC-DC converter 118′ can be connected to a power management system 113′. The electronic device 112′ can be connected to the power management system 113′. Thus the DC-DC converter 118′ can be connected to the electronic device 112′ via the power management system 113′.

The power management system 113′ can demand power from the one or more fuel cells 116′ and can deliver a power P3 to the electronic device 112′. Thus the power management system 113′ can control delivery of the power P3 to the electronic device 112′. The power P3 can be more or less than the power P2 from the DC-DC converter 118′ depending, in part, on whether the power management system 113′ has other power sources and the power demands of the electronic device 112′.

Although not shown in FIG. 2A, the power management system 113′ can include one or more hybrid batteries. A hybrid battery may be used to supplement power from the one or more fuel cells 116′ to the electronic device 112′. For example, one or more hybrid batteries can provide power beyond what can be instantly provided to the electronic device 112′ by the one or more fuel cells 116′, or provide power when a fuel supply to the one or more fuel cells 116′ is interrupted. The one or more fuel cells 116′ can provide power to the one or more hybrid batteries, for example, to replenish the hybrid batteries.

The power management system 113′ can be used to provide power to more than one electronic device. Thus the electronic device 112′ of FIG. 2A can include one or more electronic devices. The power can be provided to multiple devices simultaneously or the power management system 113′ can include one or more monitoring systems to determine which of multiple electronic devices needs power at a given point in time. FIG. 2A does not include components of the power management system 113′. The power management system 113′ is included herein to illustrate that the power supply system 100 and the other power supply systems described herein can include direct connection of a DC-DC converter to an electronic device, or the power supply systems can include a power management system between the DC-DC converter and one or more electronic devices.

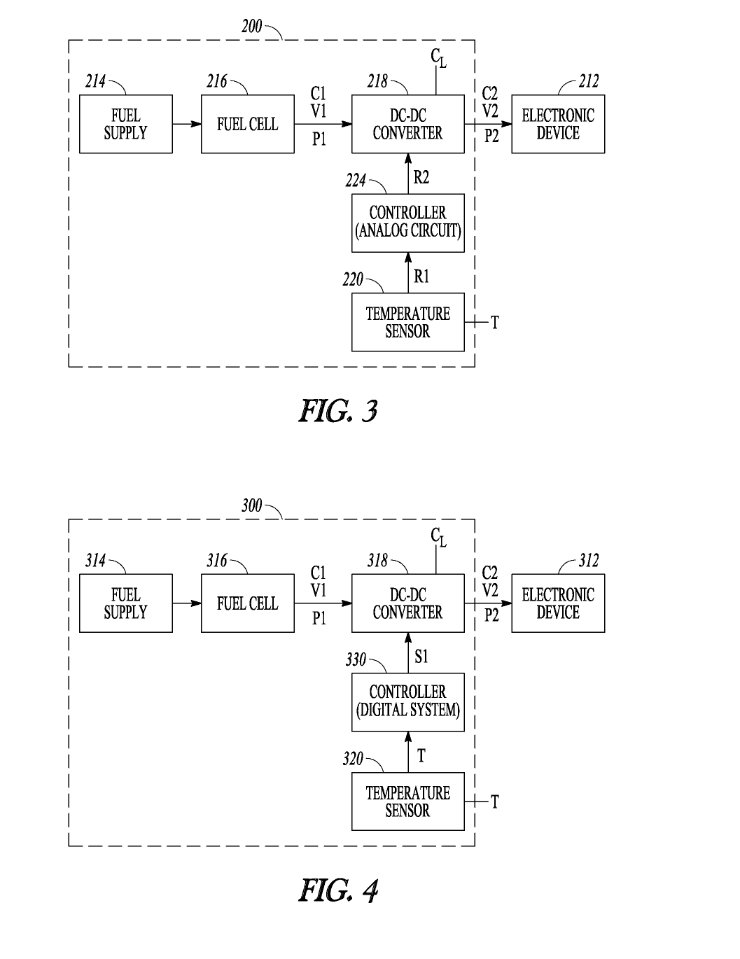

FIG. 3 shows an example of a power supply system 211 for supplying power to an electronic device 211. The power supply system 211 can be similar to the power supply system 100 described above in reference to FIG. 2, but rather than a direct coupling of the temperature sensor 121 to the DC-DC converter 118, the power supply system 211 can include a controller 224 for regulating the current limit C_{L}. In an example, the controller 224 can include an analog circuit. Similar to in system lee, a given temperature T can still be measured by a temperature sensor 221. The temperature sensor 221 can include any type of temperature sensing device. The temperature sensor 221 can include, but is not limited to, any type of Resistance Temperature Detector, thermistor, semiconductor junction, or thermocouple.

In an example, as shown in FIG. 3, the temperature T can be measured by the temperature sensor 221 as a resistance R1, which can be an input to the controller 224. The controller 224 can take the resistance R1 and provide a feedback resistance R2 to the DC-DC converter 218 that can be proportional to the resistance R1, if the DC-DC converter 218 is configured to regulate the current limit C_{L} using a resistance. Thus the varying current limit C_{L} can be based on the resistance R1 measured by the temperature sensor 221.

In an example, although the resistance R1 is shown in FIG. 3, the temperature sensor 221 can measure any parameter representative of temperature, such as, for example, voltage. The measured parameter can be input to the controller 224 in place of the resistance R1 shown in FIG. 3. Similarly, the DC-DC converter 218 can be configured to adjust the current limit C_{L} using a parameter other than a resistance, in which case an input signal to the DC-DC converter 218 can be something other than the resistance R2 shown in FIG. 3. The controller 224 can be configured to receive the parameter from the temperature sensor 221 representing the temperature T and convert that to a parameter usable by the DC-DC converter 218 for adjusting the current limit C_{L}.

Although not included in FIG. 3, a power management system, as described above in reference to FIG. 2A, can be used in combination with the power supply system 211 of FIG. 3.

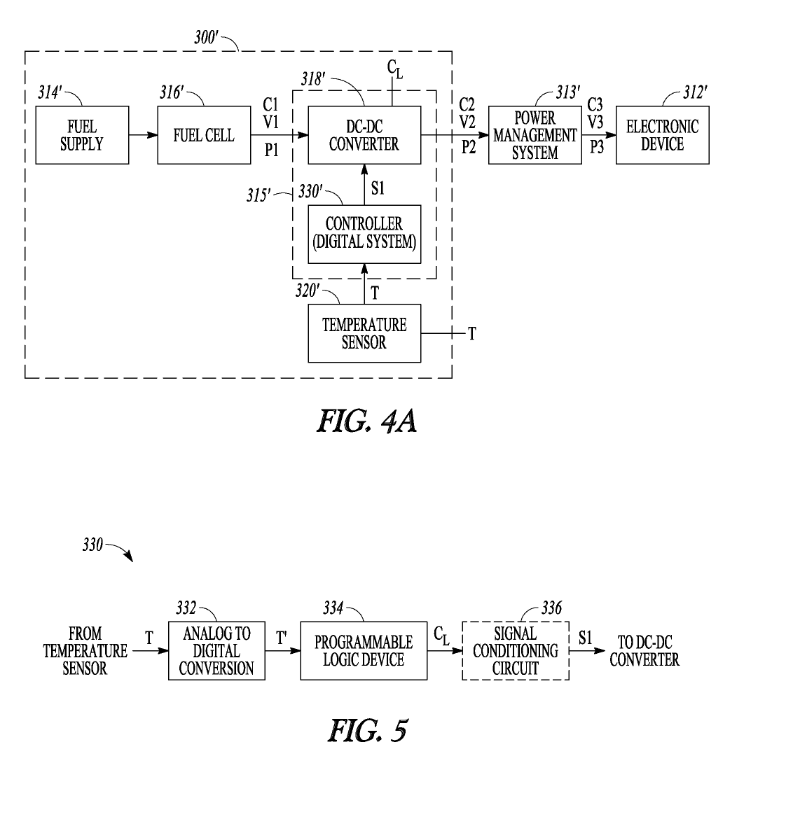

FIG. 4 shows an example of a power supply system 311 for supplying power to an electronic device 312. A controller 331 of the power supply system 311 can be a digital system as described further below in reference to FIG. 5. A temperature sensor 321 can be any type of temperature sensing element for measuring a temperature T, which can be provided or input to the controller 331. The controller 331 can determine an input signal Si to the DC-DC converter 318 based on the temperature T, as described further below. The input signal Si can correlate to the current limit C_{L} of the DC-DC converter 318.

FIG. 4A shows an example of a power supply system 311′ that can be similar to the power supply system 311 of FIG. 4. The power supply system 311′ can include a DC-DC converter 318′ and a controller 331′, which together can be part of a control system 315′ in which at least a portion of the functionality of the DC-DC converter 318′ can be implemented within the digital control system. In the system 311 of FIG. 4, the DC-DC converter 318 can include a dedicated and discrete DC-DC converter circuit or chip. In the system 311′, at least part of the functions of the DC-DC converter 318′ can be contained within the controller 331′, thus eliminating the use of a DC-DC converter chip in the system 311′. The DC-DC converter 318′ can be implemented as a software function, using, for example, a pulse width modulation program in the digital controller 331′. It is recognized that one or more analog components, such as inductors and capacitors, can be used in combination with the controller 331′ for operation of the DC-DC converter 318′.

A power management system 313′ is included in FIG. 4A to illustrate that a power management system can be used with other power supply systems, in addition to the power supply system ill′ of FIG. 2A. The power management system 313′ can operate similarly to the power management system 113′ described above in reference to FIG. 2A. In an example, the system 311′, having the control system 315′, can exclude the power management system 313′ and the DC-DC converter 318′ can be connected directly to the electronic device 312′.

FIG. 5 is an example of the digital control system 331 of FIG. 4. Other types of digital control systems or configurations can be used in addition to or as an alternative to the controller 331 shown in FIGS. 4 and 5. The digital control system 331 can include an analog to digital conversion device 332, a programmable logic device 334, and a signal conditioning circuit 336. Depending on an architecture of the DC-DC converter 318, the signal conditioning circuit 336 may or may not be present in the control system 331. All or part of the digital control system 331 can be part of the electronic device 312, or as shown in FIG. 4, the digital control system 331 can be a component of the power supply system 311.

The analog to digital conversion device 332 can be configured to convert an analog temperature measurement (e.g. the measured temperature T from the temperature sensor 321) to a digitally represented temperature, T′, which can be input to the programmable logic device 334. The programmable logic device 334 can be, for example, an Algorithmic State Machine (ASM), a microcontroller, or any other known logic device. The programmable logic device 334 can be configured to compute a current limit C_{L} for the DC-DC converter 318. The current limit C_{L} can be determined by the logic device 334 using, for example, an algorithm correlating temperature to current or using a table lookup function to determine a current limit corresponding to a particular temperature.

The computed current limit C_{L} can be provided to the signal conditioning circuit 336 such that the signal conditioning circuit 336 can translate the current limit C_{L} into an appropriate input signal Si usable by the DC-DC converter 318. In an example, the signal Si can be a resistance. In an example, the signal conditioning circuit 336 can include a digital to analog conversion such that the current limit C_{L} can be provided as an analog signal to the DC-DC converter 318. In an example, the DC-DC converter 318 can be configured to receive the current limit C_{L} from the logic device 334 and the signal conditioning circuit 336 can be excluded from the controller 331.

Other designs in addition to or as an alternative to those described herein can be used to regulate a current limit of a DC-DC converter as a function of temperature. A particular implementation of the power supply system can depend on any number of factors, including, for example, a desired level of precision of the temperature control, a level of complexity of the design of the electronic device, as well as space and cost restrictions.

For the power supply systems described herein, more than one temperature sensor can be used in order to measure more than one temperature of the power supply system and/or the portable electronic device. In that case, the current limit C_{L} to the DC-DC converter can be determined based on more than one temperature. In an example, a controller of the power supply system can be configured to receive multiple measured temperatures and adjust the current limit C_{L} accordingly.

The above description is intended to be illustrative, and not restrictive. Other embodiments can be used, such as by one of ordinary skill in the art upon reviewing the above description. For example, elements of one described embodiment may be used in conjunction with elements from other described embodiments. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

The present application provides for the following exemplary embodiments, the numbering of which is not to be construed as designating levels of importance:

Embodiment 1 provides a system for supplying power to a portable electronic device, the system comprising: a temperature sensor configured to measure a temperature of at least one of the portable electronic device and the system; one or more fuel cells configured to produce electrical power; and a DC-DC converter comprising an input connected to the one or more fuel cells and an output connected to the portable electronic device, the DC-DC converter configured to receive the electrical power from the one or more fuel cells at an input current and an input voltage, and provide an output electrical power to the electronic device at a substantially fixed voltage, wherein the DC-DC converter comprises a current limit that varies as a function of the measured temperature.

Embodiment 2 provides the system of Embodiment 1, wherein the current limit varies as an inverse function of the measured temperature.

Embodiment 3 provides the system of Embodiments 1 or 2, wherein an amount of current produced by the one or more fuel cells decreases proportionally to a decrease of the current limit of the DC-DC converter, regardless of an amount of power demanded by the portable electronic device.

Embodiment 4 provides the system of any of Embodiments 1-3, wherein substantially all of the electrical power received by the portable electronic device is supplied by the one or more fuel cells.

Embodiment 5 provides the system of any of Embodiments 1-4, further comprising a low power mode in which the electrical power produced by the one or more fuel cells is reduced as a function of a low power demand of the portable electronic device.

Embodiment 6 provides the system of Embodiment 5, wherein the low power mode comprises an unrestricted minimum operating temperature of the one or more fuel cells.

Embodiment 7 provides the system of any of Embodiments 1-6, wherein the temperature sensor is located on an internal housing of the portable electronic device.

Embodiment 8 provides the system of Embodiment 7, wherein the system determines a temperature of an external surface of the portable electronic device based on the measured temperature of the internal housing.

Embodiment 9 provides the system of any of Embodiments 1-8, wherein the temperature sensor is located on or near the one or more fuel cells.

Embodiment 10 provides the system of Embodiment 9, wherein an anode temperature of at least one of the one or more fuel cells is measured.

Embodiment 11 provides the system of Embodiment 9, wherein a cathode temperature of at least one of the one or more fuel cells is measured.

Embodiment 12 provides the system of any of Embodiments 1-11, wherein the temperature sensor is located on or near a fuel source of the one or more fuel cells.

Embodiment 13 provides the system of any of Embodiments 1-12, wherein the temperature sensor is selected from the group consisting of a thermistor, a semiconductor junction, a resistance temperature detector, and a thermocouple.

Embodiment 14 provides the system of any of Embodiments 1-13, wherein the current limit is an input current limit.

Embodiment 15 provides the system of any of Embodiments 1-13, wherein the current limit is an output current limit.

Embodiment 16 provides the system of any of Embodiments 1-15, further comprising a power management system located between the DC-DC converter and the portable electronic device, the power management system configured to deliver power from the one or more fuel cells to the portable electronic device.

Embodiment 17 provides the system of any of Embodiments 1-16, wherein a portion of a functionality of the DC-DC converter is performed by a digital control system.

Embodiment 18 provides the system of any of Embodiments 1-17, further comprising a controller configured to monitor the measured temperature and regulate the current limit of the DC-DC converter as a function of the measured temperature.

Embodiment 19 provides the system of any of Embodiments 1-18, wherein the one or more fuel cells and the DC-DC converter are located inside the portable electronic device.

Embodiment 21 provides the system of any of Embodiments 1-19, wherein the one or more fuel cells comprises a planar fuel cell array.

Embodiment 21 provides a method of controlling a fuel cell power supply system for a portable electronic device, the method comprising: supplying current from one or more fuel cells to a DC-DC converter; and regulating a current limit of the DC-DC converter as a function of a measured temperature of at least one of the power supply system and the portable electronic device.

Embodiment 22 provides the method of Embodiment 21, wherein regulating the current limit of the DC-DC converter as a function of the measured temperature comprises limiting output current from the one or more fuel cells independent of a power demand of the portable electronic device.

Embodiment 23 provides the method of Embodiment 21 or 22, wherein the current limit of the DC-DC converter varies as an inverse function of the measured temperature.

Embodiment 24 provides the method of any of Embodiments 21-23, wherein regulating a current limit of the DC-DC converter as a function of the measured temperature comprises coupling a thermistor to the DC-DC converter.

Embodiment 25 provides the method of any of Embodiments 21-24, wherein regulating a current limit of the DC-DC converter as a function of the measured temperature comprises using a controller to monitor the measured temperature and determine the current limit of the DC-DC converter.

Embodiment 26 provides the method of any of Embodiments 21-25, wherein regulating a current limit of the DC-DC converter as a function of the measured temperature includes preventing or minimizing the one or more fuel cells from operating at a temperature greater than a maximum fuel cell operating temperature.

Embodiment 27 provides the method of any of Embodiments 21-26, wherein regulating a current limit of the DC-DC converter as a function of the measured temperature includes preventing the portable electronic device from operating at a temperature greater than a maximum electronic device temperature.

Embodiment 28 provides the method of any of Embodiments 21-27, wherein the current limit of the DC-DC converter is an input current limit.

Embodiment 29 provides the method of any of Embodiments 21-27, wherein the current limit of the DC-DC converter is an output current limit.

Embodiment 31 provides the method of any of Embodiments 21-29, wherein a portion of a functionality of the DC-DC converter is performed by a digital control system.

Embodiment 31 provides the method of any of Embodiments 21-31, wherein a power management system is located between the DC-DC converter and the portable electronic device, the power management system configured to deliver power from the one or more fuel cells to the portable electronic device.

Embodiment 32 provides a method of controlling a power supply system for a portable electronic device, the method comprising: providing a power supply system comprising one or more fuel cells and a DC-DC converter; producing electrical power from the one or more fuel cells; connecting the one or more fuel cells to the DC-DC converter such that the electrical power from the one or more fuel cells is provided to the DC-DC converter at a varying voltage and a varying current; providing an output electrical power from the DC-DC converter to the portable electronic device at a substantially fixed voltage; measuring a temperature of at least one of the portable electronic device and the power supply system; and adjusting a current limit of the DC-DC converter as a function of the measured temperature, thereby adjusting an output current from the one or more fuel cells as a function of the adjusted current limit of the DC-DC converter.

Embodiment 33 provides the method of Embodiment 32, wherein producing electrical power from the one or more fuel cells comprises operating the one or more fuel cells in a low power mode in response to a reduced power demand of the portable electronic device.

Embodiment 34 provides the method of any of Embodiments 32 or 33, wherein the low power mode comprises an unrestricted minimum operating temperature of the one or more fuel cells.

Embodiment 35 provides the method of any of Embodiments 32-34, wherein adjusting the current limit of the DC-DC converter as a function of the measured temperature comprises decreasing the current limit as the measured temperature increases.

Embodiment 36 provides the method of any of Embodiments 32-35, wherein providing the output electrical power from the DC-DC converter to the portable electronic device includes providing the output electrical power to a power management system which controls delivery of power to the portable electronic device.

Embodiment 37 provides the method of any of Embodiments 32-36, wherein a portion of a functionality of the DC-DC converter is performed by a digital control system.

Embodiment 38 provides the method of any of Embodiments 32-37, wherein measuring the temperature of at least one of the portable electronic device and the power supply system includes measuring an electrical resistance of a temperature-sensitive component in or on at least one of the portable electronic device or the power supply system.

Embodiment 39 provides the method of any of Embodiments 32-38, wherein measuring the temperature of at least one of the portable electronic device and the power supply system comprises measuring a temperature inside the portable electronic device to prevent the portable electronic device from operating at a temperature above a maximum electronic device temperature.

Embodiment 41 provides the method of Embodiment 39, further comprising calculating a temperature of an external surface of the portable electronic device based on the measured temperature inside the portable electronic device.

Embodiment 41 provides the method of any of Embodiments 32-41, wherein measuring the temperature of at least one of the portable electronic device and the power supply system comprises measuring a temperature on or near the one or more fuel cells to prevent the one or more fuel cells from operating at a temperature above a maximum fuel cell operating temperature.

Embodiment 42 provides the method of any of Embodiments 32-41, wherein the one or more fuel cells comprises a planar fuel cell array.

Embodiment 43 provides the method of any of Embodiments 32-42, wherein the one or more fuel cells and the DC-DC converter are located inside the portable electronic device.

Embodiment 44 provides the method of any of Embodiments 32-43, wherein the current limit of the DC-DC converter is an input current limit.

Embodiment 45 provides the method of any of Embodiments 32-43, wherein the current limit of the DC-DC converter is an output current limit.

Embodiment 46 provides a method or system of any one or any combination of Embodiments 1-45, which can each be optionally configured such that all steps or elements recited are available to use or select from.

The claimed invention is:

1. A system for supplying power to a portable electronic device, the system comprising:
a temperature sensor configured to measure a temperature of at least one of the portable electronic device and the system;
one or more fuel cells configured to produce electrical power; and
a DC-DC converter comprising an input connected to the one or more fuel cells and an output connected to the portable electronic device, the DC-DC converter configured to receive the electrical power from the one or more fuel cells at an input current and an input voltage, and provide an output electrical power to the electronic device at a substantially fixed voltage, wherein the DC-DC converter comprises an current limit that varies as a function of the measured temperature.

2. The system of claim 1, wherein the current limit varies as an inverse function of the measured temperature.

3. The system of claim 1, wherein an amount of current produced by the one or more fuel cells decreases proportionally to a decrease of the current limit of the DC-DC converter, regardless of an amount of power demanded by the portable electronic device.

4. The system of claim 1, wherein substantially all of the electrical power received by the portable electronic device is supplied by the one or more fuel cells.

5. The system of claim 1, further comprising a low power mode in which the electrical power produced by the one or more fuel cells is reduced as a function of a low power demand of the portable electronic device.

6. The system of claim 1, wherein a portion of a functionality of the DC-DC converter is performed by a digital control system.

7. The system of claim 1, wherein the temperature sensor is located on an internal housing of the portable electronic device and the system determines a temperature of an external surface of the portable electronic device based on the measured temperature of the internal housing.

8. The system of claim 1, wherein the temperature sensor is located on or near the one or more fuel cells.

9. The system of claim 1, wherein the temperature sensor is selected from the group consisting of a thermistor, a semiconductor junction, a resistance temperature detector, and a thermocouple.

10. The system of claim 1, wherein the current limit is one of an input current limit and an output current limit.

11. The system of claim 1, further comprising a power management system located between the DC-DC converter and the portable electronic device, the power management system configured to deliver power from the one or more fuel cells to the portable electronic device.

12. A method of controlling a fuel cell power supply system for a portable electronic device, the method comprising:
supplying current from one or more fuel cells to a DC-DC converter; and regulating a current limit of the DC-DC converter as a function of a measured temperature of at least one of the power supply system and the portable electronic device.

13. The method of claim 12, wherein regulating the current limit of the DC-DC converter as a function of the measured temperature comprises limiting output current from the one or more fuel cells independent of a power demand of the portable electronic device.

14. The method of claim 12, wherein the current limit of the DC-DC converter varies as an inverse function of the measured temperature.

15. The method of claim 12, wherein regulating a current limit of the DC-DC converter as a function of the measured temperature comprises coupling a thermistor to the DC-DC converter.

16. The method of claim 12, wherein regulating a current limit of the DC-DC converter as a function of the measured temperature comprises using a controller to monitor the measured temperature and determine the current limit of the DC-DC converter.

17. The method of claim 12, wherein the current limit is one of an input current limit of the DC-DC converter and an output current limit of the DC-DC converter.

18. A method of controlling a power supply system for a portable electronic device, the method comprising:
providing a power supply system comprising one or more fuel cells and a DC-DC converter;
producing electrical power from the one or more fuel cells;
connecting the one or more fuel cells to the DC-DC converter such that the electrical power from the one or more fuel cells is provided to the DC-DC converter at a varying voltage and a varying current;
providing an output electrical power from the DC-DC converter to the portable electronic device at a substantially fixed voltage;
measuring a temperature of at least one of the portable electronic device and the power supply system; and
adjusting a current limit of the DC-DC converter as a function of the measured temperature, thereby adjusting an output current from the one or more fuel cells as a function of the adjusted current limit of the DC-DC converter.

19. The method of claim 18, wherein adjusting the current limit of the DC-DC converter as a function of the measured temperature comprises decreasing the current limit as the measured temperature increases.

20. The method of claim 18, wherein providing the output electrical power from the DC-DC converter to the portable electronic device includes providing the output electrical power to a power management system which controls delivery of power to the portable electronic device.

21. The method of claim 18, wherein a portion of a functionality of the DC-DC converter is performed by a digital control system.

22. The method of claim 18, wherein measuring the temperature of at least one of the portable electronic device and the power supply system includes measuring an electrical resistance of a temperature-sensitive component in or on at least one of the portable electronic device or the power supply system.

23. The method of claim 18, wherein measuring the temperature of at least one of the portable electronic device and the power supply system comprises measuring a temperature inside the portable electronic device to prevent the portable electronic device from operating at a temperature above a maximum electronic device temperature.

24. The method of claim 23, further comprising calculating a temperature of an external surface of the portable electronic device based on the measured temperature inside the portable electronic device.

25. The method of claim 18, wherein measuring the temperature of at least one of the portable electronic device and the power supply system comprises measuring a temperature on or near the one or more fuel cells to prevent the one or more fuel cells from operating at a temperature above a maximum fuel cell operating temperature.
